(19) United States
(12) Patent Application Publication
(10) Pub. No.: US 2011/0059719 A1
(43) Pub. Date: Mar. 10, 2011

(54) WIRELESS EMERGENCY CALL DEVICE

(75) Inventors: Steven Spielvogel, New York, NY (US); William Robert Dorr, Keller, TX (US)

(73) Assignee: Steve Spielvogel, New York, NY (US)

(21) Appl. No.: 12/554,998

(22) Filed: Sep. 8, 2009

(51) Int. Cl. H04M 11/04

(52) U.S. Cl. 455/404.1

(57) ABSTRACT

A portable emergency call device has a single activation button to establish two way communications with an emergency call center. It is not a standard telephone and does not receive any incoming calls and can place outgoing calls only to the designated emergency call center. There is an advantage to making it waterproof.

### FIELD OF THE INVENTION

The invention relations to the emergency care industry and, in particular, to a wireless call device that may be easily carried anywhere by a disabled or elderly person and used to call or contact public or government emergency centers.

### BACKGROUND OF THE INVENTION

As the population ages, there are more and more elderly people who live by themselves, or at least spend significant parts of every day by themselves. Added to them is a growing population of disabled persons, who are also not able to completely care for themselves.

As the world's population increases and high quality healthcare becomes more accessible to the general population, the elderly and disabled population is growing. Many of these people opt to live on their own, outside of assisted living or retirement communities where emergency response networks consisting of nurses, aids, call buttons, and other technologies are prominent. To these people who choose to live independently, everyday tasks pose a large threat which could lead to injury and the need for emergency care. Getting out of the bath, draining boiling pasta, climbing or descending stairs, getting in our out of bed, and many everyday tasks could lead to a slip or fall which could pose a serious life threatening emergency to anyone, especially the elderly or disabled.

These people with increasing frequency have emergencies. They could be medical problems which could pose life or death situations. Sometimes there may be intruders seeking to take advantage of the elderly or the infirm. Other times it may be as simple as a blackout, but to an aged or infirm person that could be a frightening and/or dangerous experience. The problem could be simply that a person has difficulty in getting out of the bathtub.

For whatever the reason, these elderly and infirm people regularly need assistance. It may be medical assistance or police assistance or something of a lesser problem, where just general assistance is needed. Thus, there is a strong and gowning need for these people to have some means to call for assistance.

In many retirement communities, strategically placed around the home are call buttons. Pushing a button alerts someone in the community center that help is needed, but he does not necessarily know what type of help. He cannot speak to the caller. This is a one way system with no audio communication between the caller and the call center. All the call center can do is send someone out to the home and only after that visit can the correct emergency service be identified. This can cause critical delay in a medical emergency.

Some communities use a bank of call buttons with one for police, one for medical, one for fire, etc. Here the problem is that a disoriented elderly or infirm person in a crisis frequently cannot see which person to push, and will often times push the wrong button. Thus the button for fire may be pushed when in actuality there is a serious medical emergency. Another problem with these banks of call buttons is that they are situated in only a few places around the home. Often times they are not near the disabled or elderly person and they cannot reach any of the buttons in an emergency situation.

In many retirement and assisted living communities, it is known to provide a multitude of emergency call buttons. When a habitant presses the button, a nurse or aid station is alerted to the “emergency” and can send an employee to go and check on the situation. The downfall of this arrangement is that this is the extent of the aid, beyond calling a governmental or public emergency call center after confirming further aid is needed, that the nurse or aid station can give. Sometimes, the station cannot communicate with the person in need of assistance. They need to verify the condition of the person, in order to prevent accidental calls and to avoid wasting the time of operators of governmental or public emergency call centers. This too causes a delay in response time that could potentially cost a habitant his/her life.

It may be appreciated that many elderly individuals fall inside the bathtub or on the slick wet surface outside the tub and end up being there for long periods of time if no one checks in on them (some of them even die right where they fell). Moreover, many elderly persons have fires in their kitchens and may be in a state of panic, so they cannot call 911. Here again the importance of an easy way to call a public emergency call center is highlighted.

A partial solution can be achieved with most modern phones. Typically some of the buttons can be used for one touch dialing. Hence, a button can be dedicated to an emergency call center, like 911. Here the problem is that the phone may not be close to the victim. Further, even if the person is close to the phone, there are many buttons on the phone. In the disoriented sate, caused by a medical or other emergency, it can be hard to select the right button.

Even if a wireless or cordless phone is utilized so that the phone is always with the person, there is still the issue that, in the disorienting state of an emergency, the right button for the emergency center may not be pushed.

Shapiro (U.S. Pat. No. 4,760,593) discloses an invention similar to these call buttons. The device operates over a telephone line and permits the subscriber to press a help button which connects to a central monitoring station. The device includes a speakerphone, which can be activated by both the user and the central monitoring station, to allow for hands free operation for immobile subscribers or potentially injured users. This unit does not connect directly to a public or government emergency call center.

The use of one touch automated dialing on telephones has been known for some time, and solves the potential problem of lack of communication between the call center and person in need of assistance by providing a direct telephone line between the two. Often, the number which one touch automated dialing calls must be programmed into the phone, a difficult task for those uncomfortable with modern technology or unable to read the enclosed directions or buttons on the device. The presence of the normally present telephone buttons along with these one touch automated dialing buttons presents the problem of a person in need of help, potentially in a disoriented state, having difficulty determining the correct button to press to reach the desired emergency personnel.

Czajkowski (US Patent Publication 20080113647) discloses an inexpensive cell/wireless phone. While it does have one touch dialing, and could be set for an emergency call center, it is still a telephone with multiple buttons. Thus, there is still the problem of a victim being unable to quickly contact the emergency center.

Jensenn (EU Patent Publication EP1890468) discloses a method for pairing a wireless baby phone with at least one electronic device, particularly with a mobile telephone. It does not have an activation button for an emergency call center. As is true of all baby phones, it operates based on detection of sound and/or motion, as opposed to activation of a button.

While Uniden (Endura Wireless Cordless Phone 211272) sells a waterproof DECT phone, it is otherwise a standard telephone and does not have an activation button for an emergency call center.

Intercoms and walkie talkies likewise are not helpful for the problem, because they permit communications only with another system unit. You cannot call an emergency center.

It is known to have a pre-programmed number one touch emergency alarm system with a remote trigger that the user can wear for ease of access. Companies such as Alert1, Life Alert, Lifestation, and Phillips all provide such systems. These devices are often installed by a professional into the home and connected to a dedicated telephone line which contacts a privately held call center. Usually these services are subscription based, forcing the user to enter into an expensive monthly contract to ensure that an operator will answer when the emergency button is pressed. These systems all fall prey to some of the above mentioned downfalls of emergency call buttons such as delayed emergency response, though the wireless remote trigger overcomes the downfall of limited button location. Here again, they do not contact directly to a public or government call center. There is an intermediary, so inherently there is built-in delay in these systems.

Kearns (U.S. Pat. No. 5,305,370) discloses a personal emergency response system in which a hand held portable transmitter activates a base unit interfaced with the telephone network to dial and permit direct communications with the operator at the public safety answering point even though the user is unable to reach a telephone. It requires a remote trigger which the user can wear and then use to engage the activation button on the base unit in an emergency. By means of the remote trigger, the base unit is thus activated to dial a public or governmental emergency call center upon activation and turns on the base unit's speakerphone feature. While this allows a user not within reach of the base unit to place a call and speak to an emergency call center operator, if the user is within a different room of the same house, such as a bathroom, communication to the operator will be hindered.

Connor (U.S. Pat. No. 5,673,304) also includes a remote trigger that is carried on the user, positioned around the home, connected to detection systems such as a smoke alarm, etc. and used to remotely activate a base unit to dial a programmed phone number and activate the base unit's speakerphone. This pre-programmed number is a number which can be programmed by the user. The remote trigger does not, however, have a microphone or speaker. Thus the disabled person cannot speak to the emergency center.

Maystre (U.S. Pat. No. 6,032,036) describes similar programmability, but still fails to provide direct person to person two way communication between the emergency call center operator and the injured person. Instead, the device described by Maystre provides the user the ability to pre-record an emergency message which is sent, either by voice telephone or pager style text message, to the user programmed emergency contact numbers.

Therefore, there is an unsatisfied need for an easy to use portable emergency call device which has a single activation button to establish two way communications with a public or government emergency call center.

### SUMMARY OF THE INVENTION

It is, therefore, an object of the invention to provide a portable emergency call device which has a single activation button to establish two way communications with a public or government emergency call center.

This and other objects of the invention are achieved by a wireless waterproof emergency calling device. By pushing the button you initiate a call with an emergency center (like 911 in USA). It is not a telephone and you cannot make calls to any line other than the emergency center and it cannot receive calls. It is the goal to make contact to an emergency call center as straight forward and easy as possible.

It is an aspect of the invention that this emergency call center phone number is pre-programmed into the device depending on where the device is shipped; this will prevent the need for complicated programming by the user.

The present invention relates to a wireless (or cordless) telephone device, either connected to a public switched telephone network (PSTN), a cellular phone network, or similar phone call routing system, which can access a government run or publicly run emergency call center.

In a preferred embodiment, the device is a waterproof cordless speakerphone for emergency communication that uses DECT “Digital Enhanced Cordless Telecommunications” technology. The product consists of two major parts including the device and a base station.

Ideally, the device is compact in size with a single large activation button on the front surface of the device, which, when pressed, dials 911, or a similar number, to connect the user to an emergency operator. The device does not dial any other phone number. It is made to be 100% waterproof. The device, not the base station, contains the speaker and microphone for communication.

Another aspect of the device is that the remote device can be affixed to a person's body or near a person through means such as a belt clip, suction cup, magnet, etc.

Yet another aspect of the device is that the remote device may contain lights (LEDs) which indicate the status of the device, proper signal strength, battery power, and general operating condition.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a view showing the basic concept of the invention.

FIG. 2 is a perspective view of a base unit.

FIG. 3 is a front perspective view of the portable unit of this invention.

FIG. 4 is a rear view, partially broken away, of the portable unit of this invention.

FIG. 5 is a side view of the portable unit of this invention.

FIG. 6 is a side view, broken away, showing the elements constituting the portable unit.

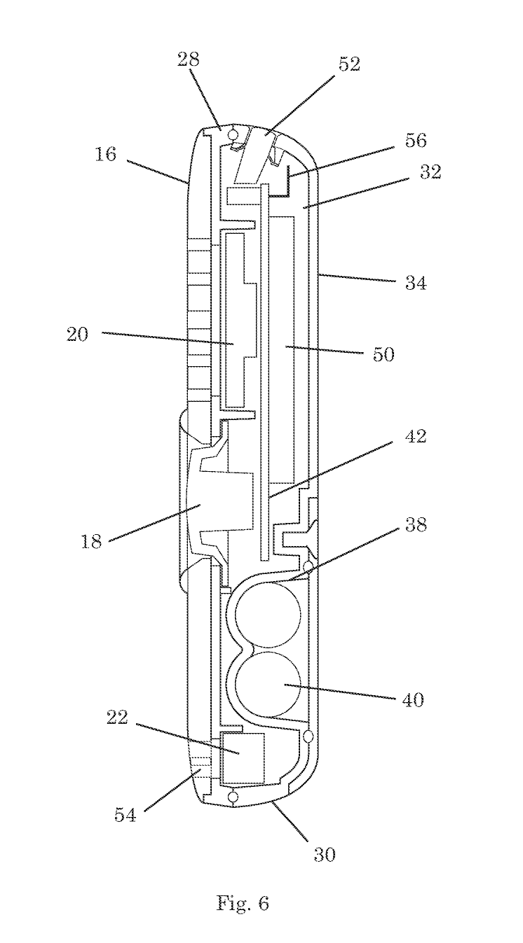

FIG. 7 is a rear view of the portable unit of the invention.

FIG. 8 is a perspective view of an alternate embodiment of the portable unit on which there are iterations.

FIG. 9 is a perspective view of an alternate embodiment showing a suction cup.

FIG. 10 is a perspective view of an alternate embodiment showing a belt clip.

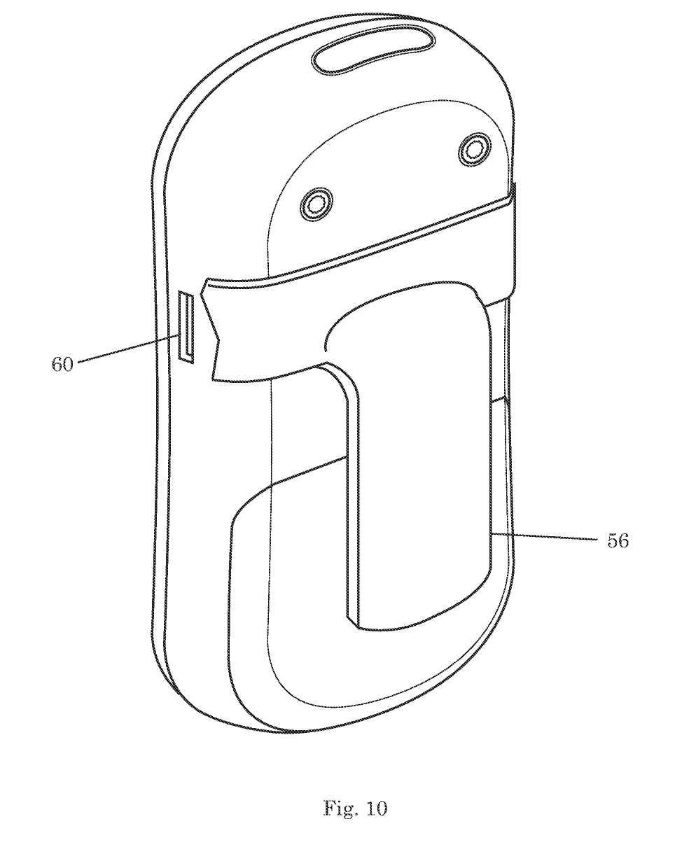

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

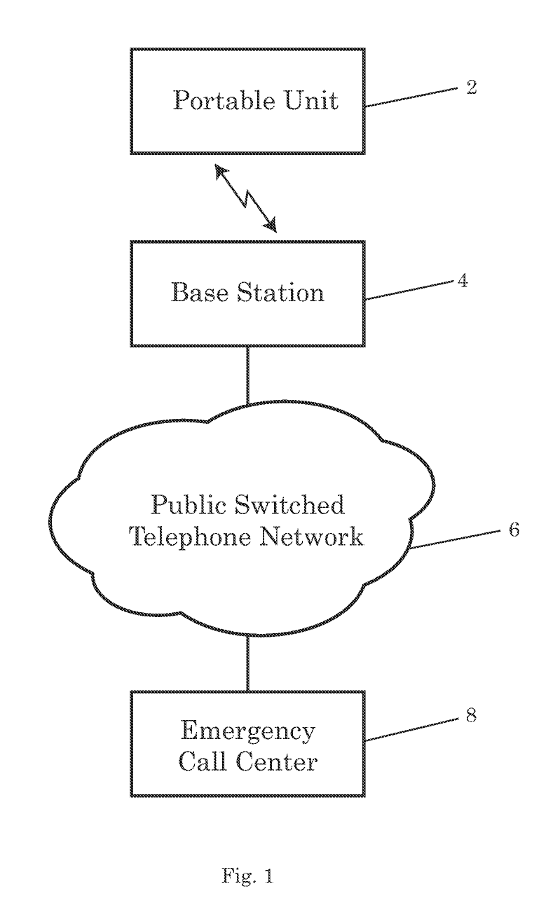

As shown in FIG. 1, the basic concept of the invention is not complicated. The emergency communication device consists of a portable unit 2 as will be hereinafter described. By any suitable means, it is connected in a wireless manner (or using cordless technology) to a base station 4. The base station is then connected by a telephone communications network 6 to an emergency services call center 8.

The emergency services call center is preferably a governmental or public call station, like those designated for “911” service in the USA, wherein there are operators available 24 hours a day to receive calls and to dispatch emergency service people, like policemen, firemen, medic alert professionals, medical assistance personal and other emergency service workers. Such call centers are almost universal through the United States and similar call centers are being established with increasing frequency around the world. In Europe, for example, the emergency number is usually 112. Japan uses 110 for police and 119 for medical emergencies and fire. Canada also uses 911, and Mexico typically uses 066, 060 or 080. Based on where the product is to be sold will depend on which emergency number is programmed. Suffice it to say that the unit should not be moved from country to country without first re-programming to enter the emergency number for the new country. Otherwise the portable unit will dial the wrong number when activated.

As defined herein, for purposes of this invention, the telephone communications network 6 may be any communications network for establishing telephone communications. Thus, it may be standard telephone land lines, or it may be cellular over the air communications networks.

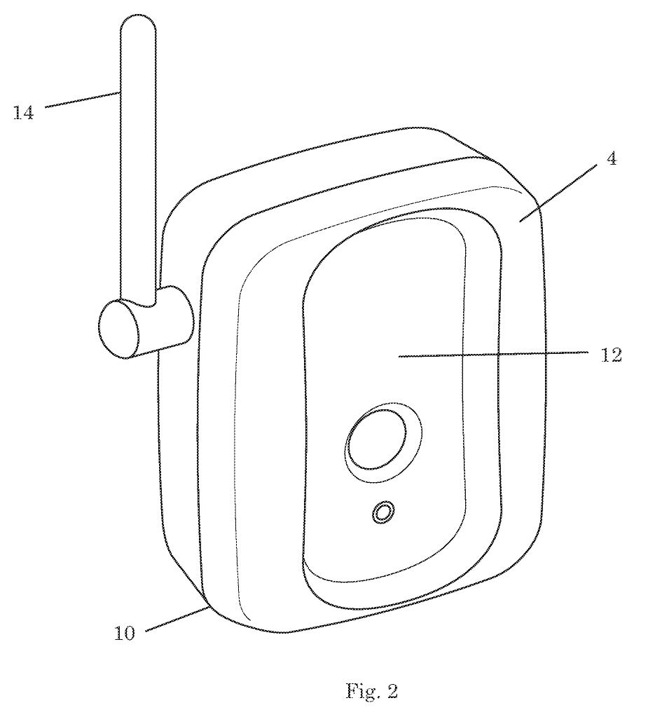

FIG. 2 illustrates the base unit 4 of the herein disclosed invention and it may be any known type of base unit for communication with a wireless or cordless or portable telephone. As is know in the field, it may be connected by a standard telephone wire to a conventional phone jack of a landline telephone line (not shown) or it may be a cell phone type unit and operate over the standard cell phone over the air lines. Either way it communicates with the standard telephone communications lines in the geographical area in which it is placed.

As shown, the base unit may be a standard rectangular box 10, as is well known, and include side, front, back, top and bottom surfaces to define the unit. A depression 12 or cradle may be defined on the top to hold the portable unit 2 when it is not in use. The antenna 14 may be externally mounted or internal (not shown) or there may be wireless protocols for communicating with the portable unit, such as Bluetooth or DECT. The specific design of the base unit is not pertinent to the invention.

While the invention is illustrated with one base unit and one portable unit, it should be appreciated that one base can be used with multiple portable units and that there can be a synching mechanism so that additional devices can be synchronized to the same base.

It is the portable unit 2 that is the salient part of the invention. In the preferred embodiment it is made of plastic, but any suitable material may also be used. To facilitate its use, it preferably should be made small so it is unobtrusive and easy to carry. In one embodiment, it may be 102.60 mm high, 58.50 mm wide and 27 mm thick. It may be appreciated that any suitable dimensions are acceptable and these dimensions are just one example presented for illustrative purposes.

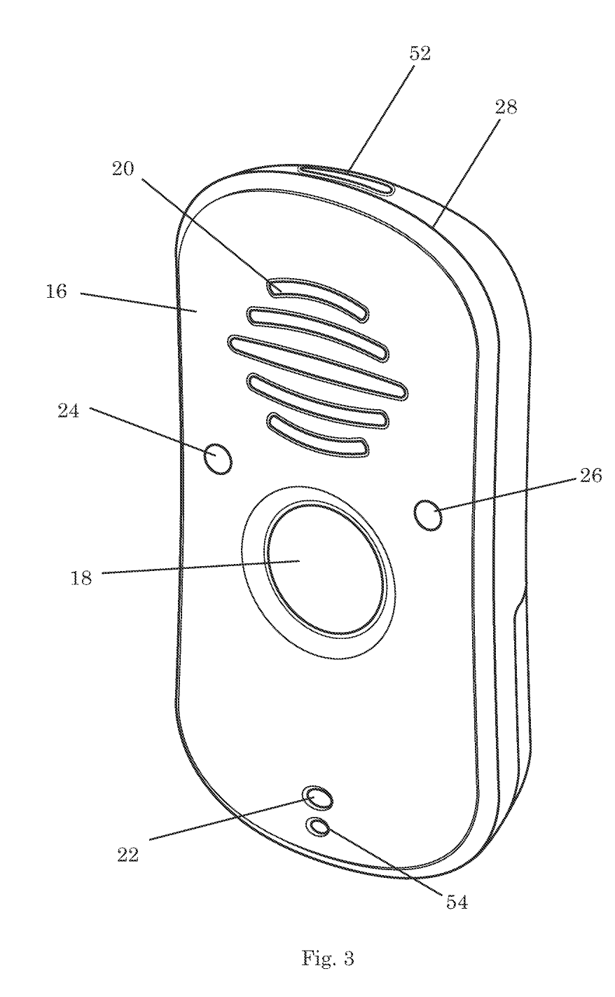

Referring generally to FIG. 3, the portable unit 2 has a smooth clean front or top surface 16 and includes the activation button 18, a speaker 20 and a microphone 22. Conventional speakers and microphones may be used and any suitable number of slots or openings may be provided for that purpose. In the accompanying drawing, the number of openings for each is only for illustrative purposes. There are some technologies that operate well with only a single small opening. Such technologies may be especially suitable in order to maintain a waterproof device, as hereinafter explained.

If desired, LEDs 24 and 26 may be used to respectively show system status and/or battery status. For example, a green indication may indicate the system is operational and the batteries are okay, whereas a red indication may indicate weak batteries or a problem with the operational system.

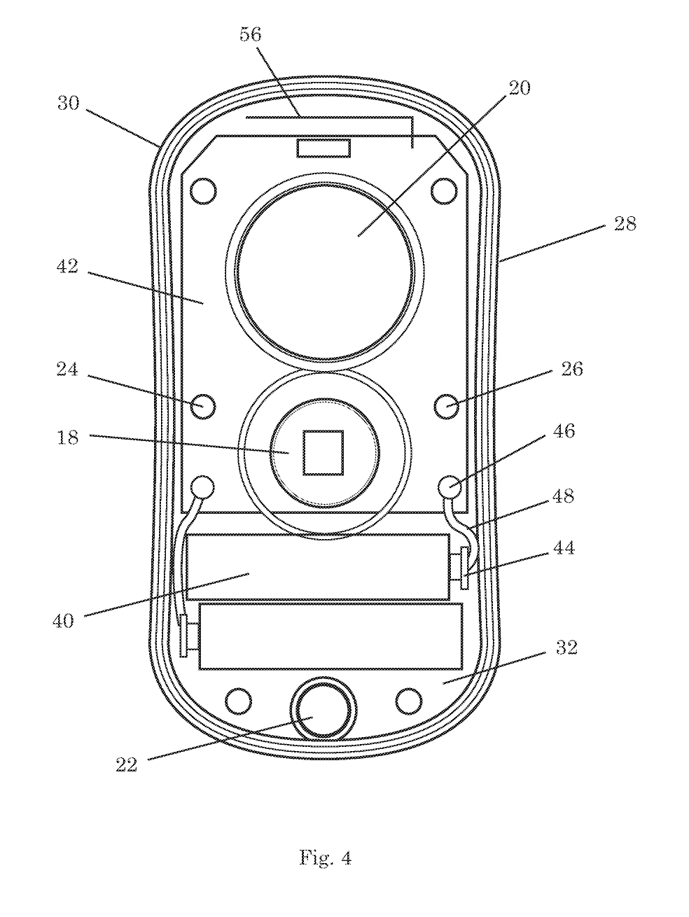

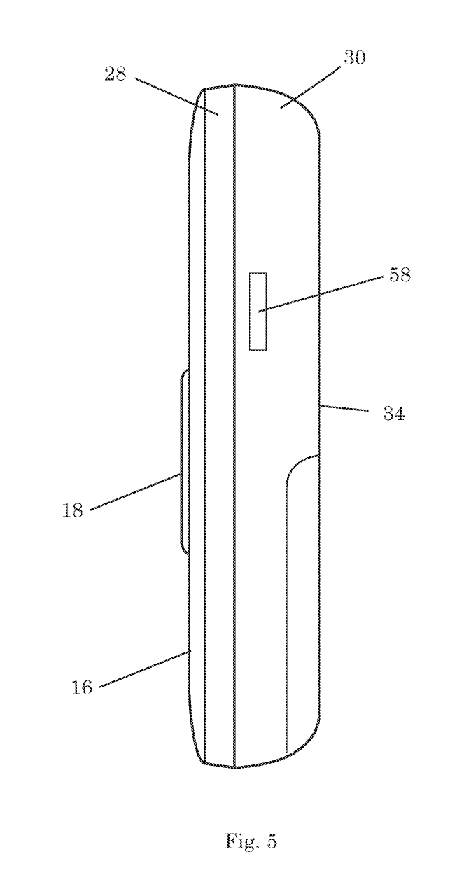

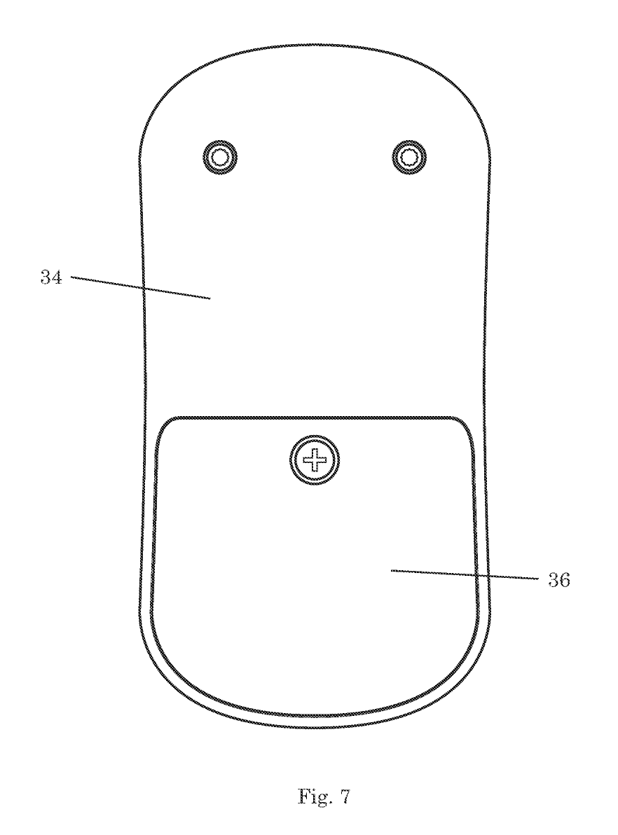

As shown in FIGS. 4, 5, and 7, the casing 28 for the portable unit 2 my further include a bottom or back surface 34 and a raised wall 30 around the periphery to define an interior 32 wherein the elements of the portable unit are disposed. In any suitable manner, as by screws or adhesives, the top cover 16 is secured to the casing 28. A cover plate 36 is used in any known manner on the bottom surface 34 to cover a battery compartment 38. In a preferred embodiment 2 AAA batteries 40 are used, but any suitable battery (or batteries) may be used, depending on the power requirements. If desired, rechargeable batteries are effective.

A circuit board 42 is disposed in the interior 32 of the casing. Each of the batteries 40 is positioned so that their terminals engage contacts 44 within the battery compartment. These contacts are then electrically connected to terminal points 46 on the circuit board. This can be done in any suitable manner. One method is to solder the ends of wires 48, or other electrical connectors, to the contacts 44 and to solder the other ends of the wires to the terminal points 48 on the circuit board. Alternatively, the contacts 44 may be printed directly on the circuit board, as is known in the industry.

On the circuit board 42 a RF module 50 is created. This module acts as a controller and effects the operation of the unit. Also connected on the circuit board and electrically connected to the RF module are the activation button 18, the speaker 20, the microphone 22 and the optional LEDs 24 and 26. When programming the RF module, it is set so that outgoing calls can be made to only a designated emergency center phone (typically 911 in the USA) and it is set so that incoming calls cannot be received.

Stated succinctly, the user takes the portable unit 2 and carries it with him or places it nearby. If an emergency arises, the user touches the activation button 18 and there is (over either standard land lines or over cell lines) telephone communication with an emergency operator. In particular, depressing the key on the front surface of the device automatically dials the factory programmed emergency services phone number for the country in which the device has been purchased (911 in most of the USA). A command to dial the number is sent from the portable device to the base unit wirelessly using, for example, DECT (digitally enhanced cordless telecommunications) standard. The base then dials the emergency services number and the signal is transmitted over the PSTN (Public Switched Telephone Network). In this regard, the device operates as a conventional telephone, albeit that only one pre-designated phone number can be dialed.

Using the speaker and microphone, the disabled or elderly person can talk directly to the emergency operator and explain the exact emergency and location. Thereafter, the emergency operator can speedily send the correct emergency response team to the user. There are no extraneous buttons to confuse the possibly disoriented elderly or disabled person. Further the call goes right to the government maintained emergency center and help can be immediately sent to the person.

Depressing the activation button on the front surface a second time disconnects the call.

The device is compact in size with a single large activation button 18 on the front surface 16 of the device, which, when pressed, dials a predestinated emergency call center (generally 911) to connect the user to an emergency operator. No other phone number can be mistakenly dialed. Preferably, the device is 100% waterproof. Therefore, an elderly or disabled person can place the device inside a shower or bathtub for use in the event an emergency arises. A drainage hole 54 is added for the purpose of letting water trapped within the device escape.

If desired, the device has a test button 52 on one of the side surfaces of the casing. This may be used to test both the system status and the battery status. Two (2) LED's 24 and 26 are optionally provided on the device's front surface to indicate battery and system status. One LED indicates the Battery Status; green=OK, red=replace battery. The second LED indicates system status; green=OK, red=system is not working.

To synchronize the portable device and the base unit, one presses and holds the test button 52 for 5 seconds and this engages the portable device into a registration mode. A press of the button on the base and the system registers the portable device. A tone may optionally sound and the light on the base can optionally flash rapidly 3 times. In this way the user knows the portable device and its base are synchronized.

The base station 4 (like a standard cordless phone base) is connected to any home phone jack, or may be connected to a cell phone network. In some embodiments, the base station can also permit the easy addition and use of multiple devices (up to 6 or even more) even after the initial product purchase and installation. Preferably, the base station can be placed on a horizontal flat surface or mounted on a standard telephone wall jack plate.

In a preferred embodiment, the microphone 22 may be provided with a drain hole 54 which evacuates water from the cavity in front of the microphone through the use of gravity or by shaking the unit. The basic idea is that gravity drains any excess water that is trapped in the space in front of the microphone component, keeping the microphone clear for use even in a wet situation. A similar concept may be used for the speaker 20.

In order to improve the usefulness of the device, DECT “Digital Enhanced Cordless Telecommunications” technology may be utilized. This provides for extended phone range (approximately 300 meters) and improved sound quality. The transmission is optimized for maximum battery life (user can speak with 911 or emergency operator for a full 30 minutes) and batteries do not need to be changed for one full year. In most applications, it is adequate for the phone device to use two standard AAA batteries. DECT technology operates with far less interference than non-DECT cordless phone systems and there is a low risk of interference from home appliances and wifi devices.

Based on the configuration, an external antenna is not required. The antenna 56 is mounted inside the device, generally on the circuit board.

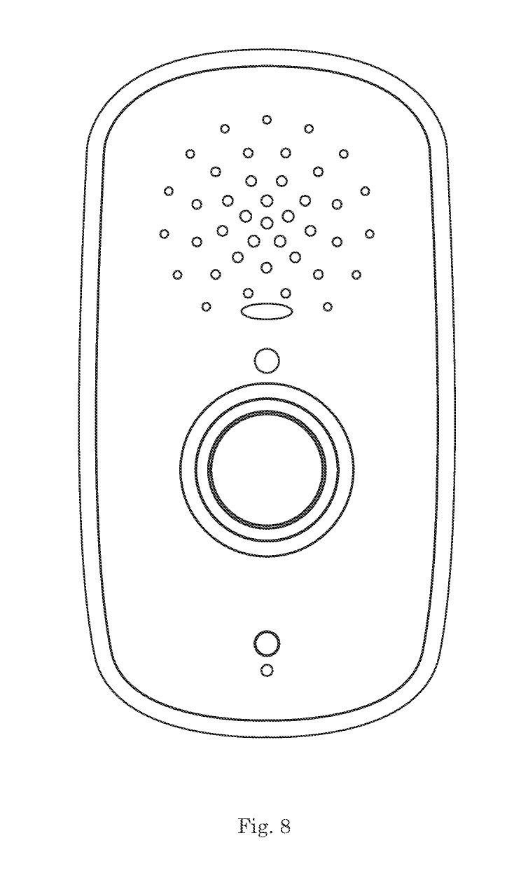

The device is intended to be held in emergency situations (and can be carried in the hand). In some applications (see FIG. 8), the device may have a piece of rubber on both of the side edges, or a piece of rubber around the entire perimeter 30 of the device (or one iteration might even have the entire back of the device made of rubber or some other non-smooth surface). This will guard against the device falling out of one's hand when wet.

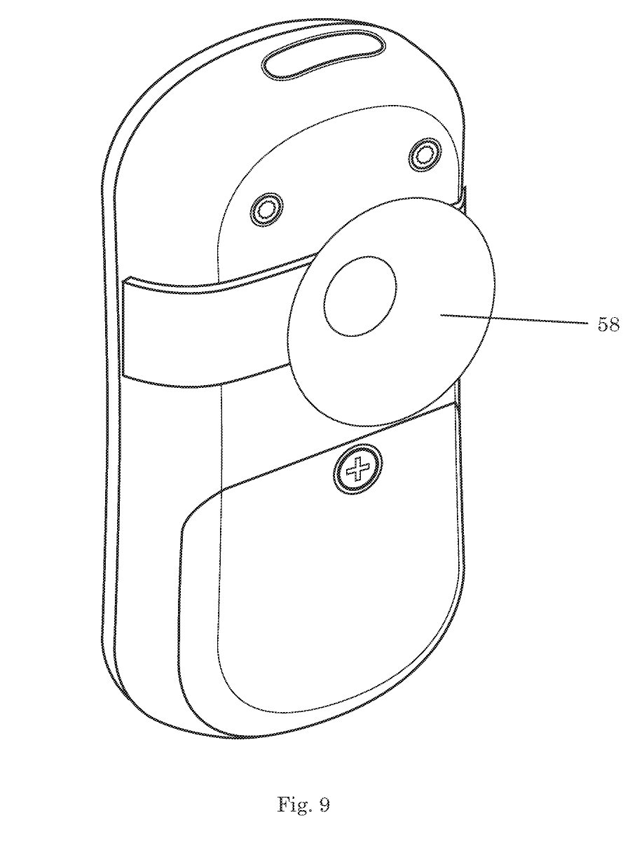

To facilitate use, the device can be held on a user's clothing, such as by a belt clip 60. It may also be fastened to a bathtub with a suction device 58 (FIG. 9). The device can also be attached to a lanyard or necklace for the user to wear around their neck. Recesses may be added to allow for the attachment of such positioning devices.

While not mandatory, for better ease of operation, in a preferred embodiment, the portable device is made waterproof. The International Electrotecnical Commission (IEC) publishes standards for electrical devices. Among the various standards are ones for submission in or exposure to water. As defined in international standard IEC 60529, it classifies the degrees of protection provided against the intrusion of water (and other objects and media) in electrical enclosures. For the herein device, it will generally be adequate if it meets the IPX7 (also known as JIS7) standards. This means the device can stay submerged for at least 30 minutes at a depth of 1 meter without damage. If the device is submerged at a lower depth, then it can stay submerged longer. In some embodiments it may be desirable to use IPX8 standard to permit continuous underwater use.

Waterproofing may be effected by any means known in the industry. For example, the device may be sealed by ultrasonic welding or other means to permanently join the case parts. Another way is to use rubber seals that are compressed with assembly screws to create a watertight barrier around major case joints. Another possibility is to apply silicone material to the inside of some areas, such as the speaker and/or microphone areas.

To the best of Applicant's knowledge, no other cordless emergency device gives the consumer the ability to have one base with multiple emergency devices, or gives the consumer the ability to add on/use additional emergency devices with the original base.

Moreover, to the best of Applicant's knowledge, no other cordless emergency device uses DECT technology or is 100% waterproof.

While certain features of the invention have been illustrated and described herein, many modifications, substitutions, changes, and equivalents will now occur to those of ordinary skill in the art. The invention is described in detail with reference to a particular embodiment, but it should be understood that various other modifications can be effected and still be within the spirit and scope of the invention. It is, therefore, to be understood that the appended claims are intended to cover all such modifications and changes as fall within the true spirit of the invention.

1. An emergency communication device having a portable, cordless phone and a corresponding base unit connected to a telephonic communication network, a RF module for wireless communication with said telephonic communications network and stored within said cordless phone, a microphone electrically connected to said RF module, and a speaker electrically connected to said RF module, wherein the improvement comprising:
said RF module being programmed to prevent receipt of incoming calls, programmed for permitting outgoing calls to only a designated public emergency call station, and using Digital Enhanced Cordless Telecommunications (DECT) technology for communicating with said telephonic communications network via said corresponding base unit; and
an activation button for establishing two way telephonic communication between said portable phone and said public emergency call station via said RF module, said base unit, and said telephonic communications network, and said activation button being electrically connected to said RF module.

2. (canceled)

3. An emergency communication device according to claim 1, wherein said portable phone further comprising: LEDs to indicate system status and power status; and a test button to activate a test system to check the device and power status.

4. An emergency communication device according to claim 1, wherein an outer surface of said portable phone being made of a non-smooth material.

5. An emergency communication device according to claim 4, wherein said outer surface of said portable phone having rubber applied to it.

6. An emergency communications device according to claim 1, further comprising a suction device mounted on said portable phone.

7. An emergency communications device according to claim 1, further comprising a belt clip mounted on said portable phone.

8. An emergency communications device according to claim 1, further comprising an antenna for said RF module positioned within said portable phone.

9. An emergency communications device according to claim 1, wherein said portable phone being waterproof.

10. (canceled)

11. A device according to claim 1, further comprising multiple portable cordless phones synchronized to said base unit.

12. (canceled)

13. (canceled)

14. (canceled)

15. (canceled)

16. (canceled)

17. (canceled)

18. (canceled)

19. (canceled)
